(19) United States
(12) Patent Application Publication
(10) Pub. No.: US 2023/0118714 A1
(43) Pub. Date: Apr. 20, 2023

(54) KEYBOARD MODULE

(71) Applicant: Chicony Electronics Co., Ltd., New Taipei City (TW)

(72) Inventor: Huai-Chih Chen, New Taipei City (TW)

(73) Assignee: Chicony Electronics Co., Ltd., New Taipei City (TW)

(21) Appl. No.: 17/879,781

(22) Filed: Aug. 3, 2022

(30) Foreign Application Priority Data
Oct. 14, 2021 (TW) 110138067

(51) Int. Cl. G06F 3/02

(52) U.S. Cl. CPC G06F 3/0216

(57) ABSTRACT

A keyboard module including a first body and a second body is provided. The first body includes a first connecting part. The second body is electrically connected to the first body and includes a second connecting part. The second connecting part is movably disposed at the first connecting part, so that the second body is movably disposed at a first position and a second position related to the first body along a first axis. Besides, the second body is rotatably disposed at at least one of the first position and the second position related to the first body along a second axis.

### CROSS-REFERENCE TO RELATED APPLICATION

This application claims the priority benefit of Taiwan application serial no. 110138067, filed on Oct. 14, 2021. The entirety of the above-mentioned patent application is hereby incorporated by reference herein and made a part of this specification.

### BACKGROUND

### Technical Field

The invention relates to a keyboard module, and particularly relates to a keyboard module with adjustable position and angle.

### Description of Related Art

When typing on traditional keyboards, users tend to bend their wrists slightly due to the design of the traditional keyboards. The users must keep an uncomfortable operating posture in accordance with the positions of the keys, which eventually will cause wrist pain.

In addition, when playing games with a traditional keyboard, a user needs to bend the wrist of one hand that presses the most used keys since positions of the most used keys (such as the WASD keys and the arrow keys) may be affected by the design of the traditional keyboard. Meanwhile, the usage range of a mouse is affected by the shape of the traditional keyboard, so the other hand that controls the mouse may be in an uncomfortable operating posture, which eventually may cause wrist pain as well.

### SUMMARY

The invention is directed to a keyboard module, which reduces probability of wrist pain caused by the wrist being in an uncomfortable operating posture when a user uses the keyboard to type or play games for a long time.

The invention provides a keyboard module including a first body, where the first body includes a first connecting part; and a second body, which is electrically connected to the first body and includes a second connecting part. The second connecting part is movably disposed at the first connecting part, so that the second body is movably disposed at a first position and a second position related to the first body along a first axis. The second body is rotatably disposed at at least one of the first position and the second position related to the first body along a second axis.

In an embodiment of the invention, the first body includes a first bottom case and a first positioning member fixed to the first bottom case. The second body includes a second bottom case, and the first positioning member extends to the second bottom case. The second bottom case includes a plurality of second positioning members, and the first positioning member is movably positioned to one of the plurality of second positioning members.

In an embodiment of the invention, the first positioning member includes a first sub-section and a second sub-section. When the second body is located at the first position relative to the first body, the first sub-section is positioned to one of the second positioning members. When the second body is located at the second position relative to the first body, the second sub-section is positioned to one of the second positioning members.

In an embodiment of the invention, an outer contour of any one of the first sub-section and the second sub-section corresponds to an outer contour of the second positioning member in a male-female fitting manner.

In an embodiment of the invention, the second positioning members are arranged along an arc. The second bottom case includes a reinforcing wall connected between the plurality of second positioning members.

In an embodiment of the invention, the first positioning member includes a hollow region, which is adapted to provide a space for deformation of the first positioning member, so that the first positioning member is clipped into or separated from one of the second positioning members.

In an embodiment of the invention, the first body includes a first keyboard member, a first circuit member, a first support member and the first bottom case arranged in sequence along the second axis. The second body includes a second keyboard member, a second circuit member, a second support member and a second bottom case arranged in sequence along the second axis. The first positioning member and the second positioning member are located between the second support member and the second bottom case.

In an embodiment of the invention, the first body includes an extension member fixed to the first bottom case and extending from a position between the first support member and the first bottom case to a position between the second support member and the second bottom case. The first positioning member is fixed to the extension member.

In an embodiment of the invention, the keyboard module further includes a flexible flat cable, which is connected to the first circuit member and the second circuit member.

In an embodiment of the invention, the first connecting part includes a sliding rail, the second body includes a second keyboard member, an interference member is disposed on the sliding rail or the second keyboard member, and the second connecting part is disposed through the interference member, the sliding rail and the second keyboard member.

In an embodiment of the invention, the interference member includes a through slot, the second connecting part includes a sliding block and a position-limiting portion, the sliding block is disposed through the through slot, the sliding rail and the second keyboard member, and the position-limiting portion is connected to the sliding block and located beside the interference member.

In an embodiment of the invention, the interference member includes a plate body and at least one first positioning portion, and the through slot is formed in the plate body. When the position-limiting portion is staggered from the at least one first positioning portion, the second body is adapted to move along the first axis. When the position-limiting portion is rotated to engage with the at least one first positioning portion, movement of the second body on the first axis is limited.

In an embodiment of the invention, the position-limiting portion has at least one arc-shaped groove on a side facing the sliding block, and the at least one first positioning portion is convex.

In an embodiment of the invention, the interference member is disposed on a bottom surface of the first connecting part, the through slot corresponds to the sliding rail, and the sliding block is sequentially disposed through the through slot, the sliding rail and the second keyboard member.

In an embodiment of the invention, the interference member further includes at least one second positioning portion. When the position-limiting portion is staggered from the at least one second positioning portion, the second body is adapted to move along the first axis. When the position-limiting portion is rotated to engage with the at least one second positioning portion, movement of the second body on the first axis is limited.

In an embodiment of the invention, the at least one first positioning portion includes two first positioning portions, and the at least one second positioning portion includes two second positioning portions. The two first positioning portions are located on two sides of the through slot, the two second positioning portions are located on the two sides of the through slot, the position-limiting portion is long stripe-shaped, a width of the position-limiting portion is less than a distance between the two first positioning portions and less than a distance between the two second positioning portions, and a length of the position-limiting portion is greater than the distance between the two first positioning portions and greater than the distance between the two second positioning portions.

In an embodiment of the invention, the second keyboard member includes a hole, the interference member is disposed on a bottom surface of the second keyboard member, the through slot corresponds to the hole, the second connecting part includes a fixing member, and the sliding block sequentially passes through the through slot, the hole and the sliding rail to be connected to the fixing member, so that the second keyboard member is located between the position-limiting portion and the fixing member.

In an embodiment of the invention, the fixing member includes a stopper portion facing the sliding rail. The sliding rail includes a first end, a second end and a middle section connected to the first end and the second end. A width of the first end and a width of the second end are greater than a width of the middle section, a length of the stopper portion is less than the width of the first end and the width of the second end and greater than the width of the middle section, and a width of the stopper portion is less than the width of the middle section.

In summary, in the keyboard module of the invention, as the second body freely switches between the first position and the second position relative to the first body, when typing and operating direction keys, a user may adjust the keyboard module along the first axis to a position where the wrist stays comfortable. In addition, in the keyboard module of the invention, the second body is rotatably disposed on the first body, so that the user may not only adjust a wrist position along the first axis but also rotate the second body along the second axis to improve the comfort of the wrist during use. In this way, when typing or playing games with the keyboard module of the invention, the user may keep the wrist in a comfortable operating posture, so as to improve the problem of wrist pain caused by typing or playing games with a keyboard for a long time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a keyboard module according to an embodiment of the invention.

FIG. 2A and FIG. 2B are schematic top views of a second body of the keyboard module of FIG. 1 rotatably disposed on a first body at a first position.

FIG. 3A and FIG. 3B are schematic top views of the second body of the keyboard module of FIG. 1 rotatably disposed on the first body at a second position.

FIG. 4A is an exploded view of a keyboard module of FIG. 1.

FIG. 4B is a schematic diagram of a first positioning member and a second positioning member of FIG. 4A.

FIG. 5A and FIG. 5B are respectively schematic top views of internal positioning members of the keyboard module of FIG. 2A and FIG. 2B.

FIG. 6A and FIG. 6B are respectively schematic top views of the internal positioning members of the keyboard module of FIG. 3A and FIG. 3B.

FIG. 7 is a schematic enlarged view of a sliding block and a position-limiting portion of the second connecting part of FIG. 1.

FIG. 8A to FIG. 8D are schematic diagrams illustrating movement of the position-limiting portion of the keyboard module of FIG. 1 relative to an interference member.

FIG. 9 is a schematic exploded view of a keyboard module according to another embodiment of the invention.

FIG. 10 is a partial schematic view of FIG. 9 from another viewing angle.

FIG. 11A and FIG. 11B are schematic diagrams of movement of a position-limiting portion of FIG. 9 relative to an interference member.

FIG. 12A and FIG. 12B are schematic top views of a second body of the keyboard module of FIG. 9 that is rotatably disposed on a first body at a first position.

FIG. 13A and FIG. 13B are schematic top views of the second body of the keyboard module of FIG. 9 that is rotatably disposed on the first body at a second position.

### DESCRIPTION OF THE EMBODIMENTS

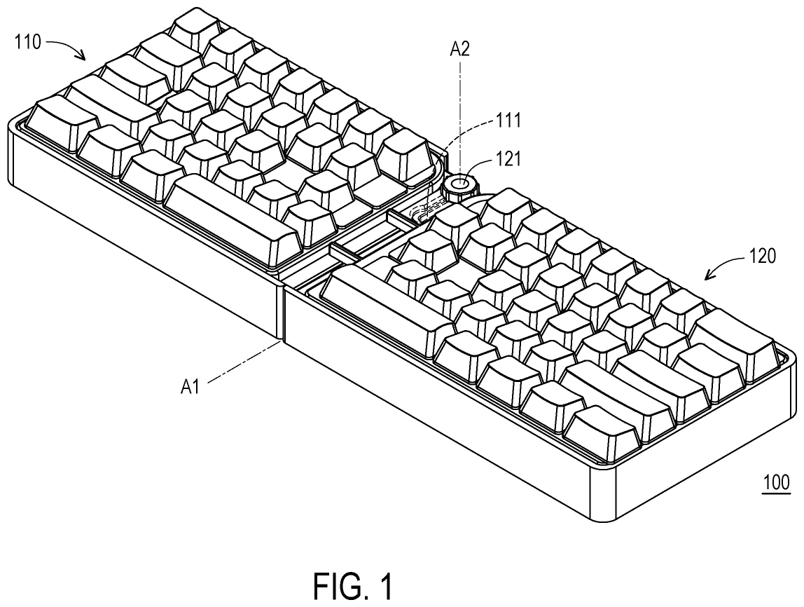

FIG. 1 is a schematic diagram of a keyboard module according to an embodiment of the invention. Referring to FIG. 1, the keyboard module 100 in the embodiment is, for example, a keyboard provided on a notebook computer, but in other embodiments, the keyboard module 100 may also be a standard keyboard with independent numeric keys, and the type of the keyboard module 100 is not limited thereto.

The keyboard module 100 includes a first body 110 and a second body 120. The second body 120 is electrically connected to the first body 110. In the embodiment, the first body 110 and the second body 120 are, for example, a left body and a right body of the keyboard module 100, so as to be easily adjusted to match positions of the left and right hands. In other embodiments, if there are other requirements, the first body 110 and the second body 120 may also be an upper body and a lower body of the keyboard module 100, and classification of the first body 110 and the second body 120 is not limited thereto.

In the embodiment, a position and an angle of the second body 120 relative to the first body 110 may be adjusted to provide the user with a more comfortable use state, which will be described below.

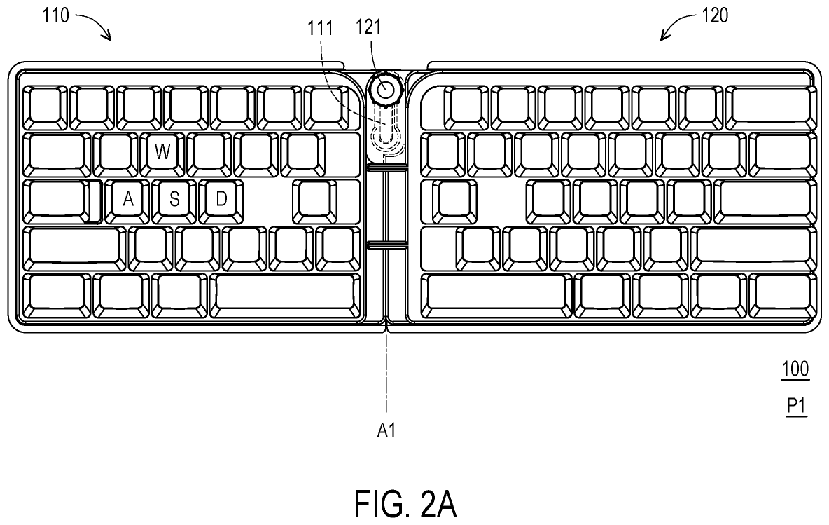

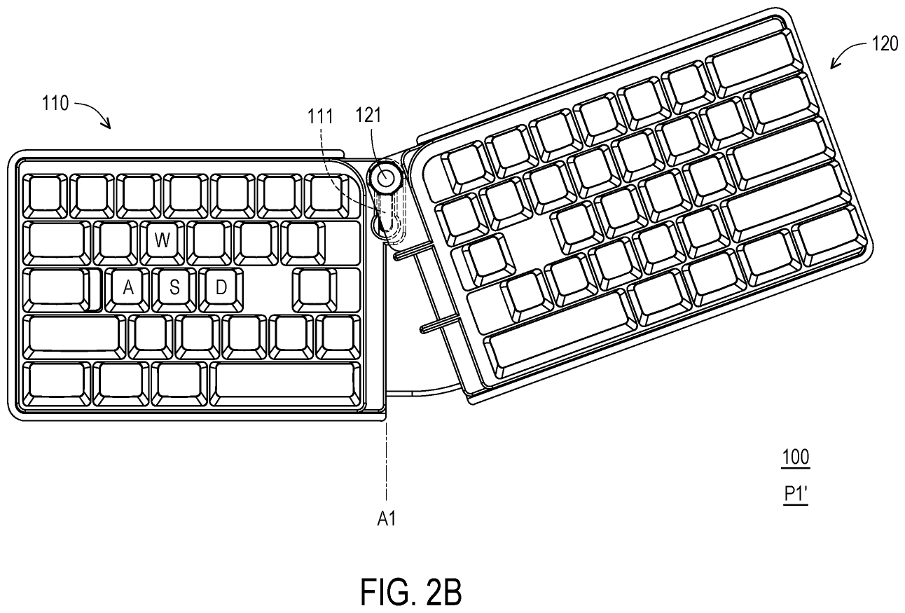

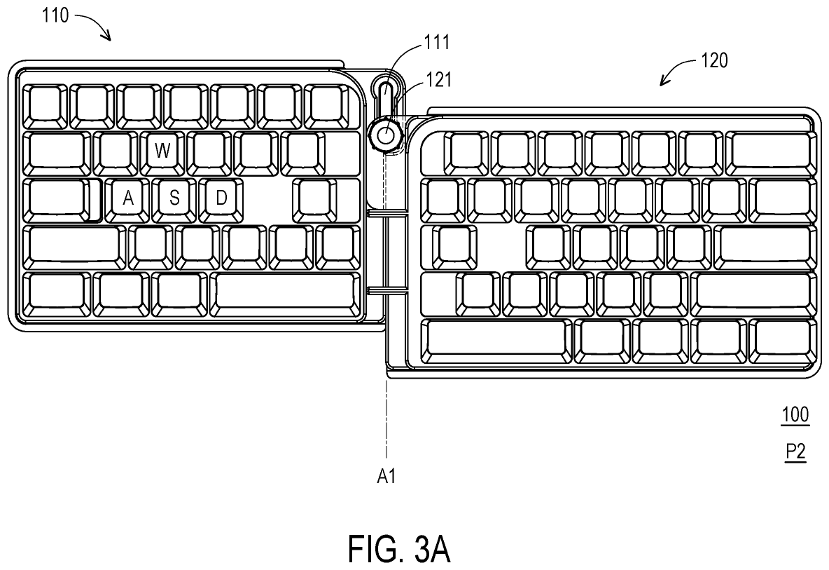

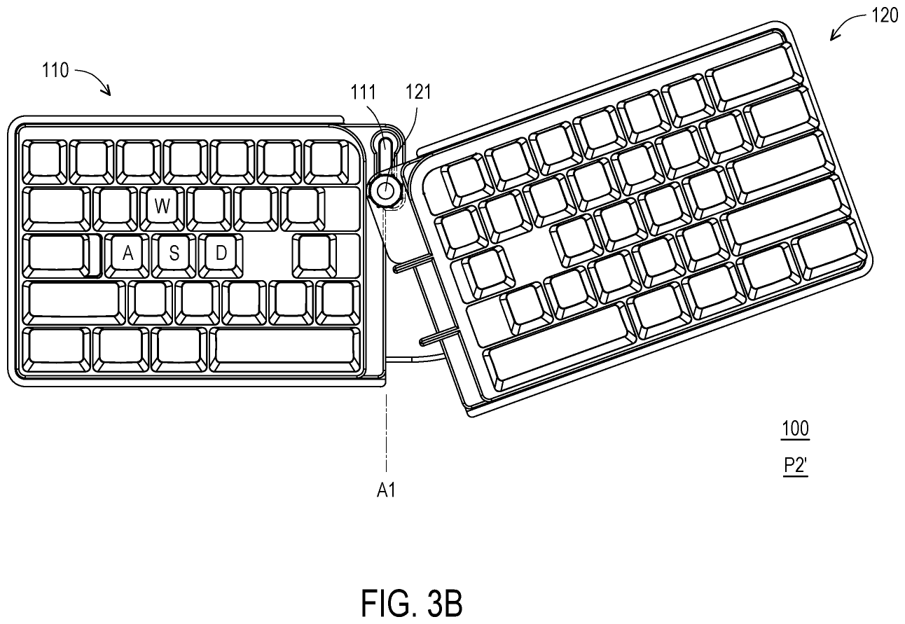

FIG. 2A and FIG. 2B are schematic top views of the second body of the keyboard module of FIG. 1 rotatably disposed on the first body at a first position. FIG. 3A and FIG. 3B are schematic top views of the second body of the keyboard module of FIG. 1 rotatably disposed on the first body at a second position.

Referring to FIG. 1 to FIG. 3B, in the embodiment, the first body 110 includes a first connecting part 111, and the second body 120 includes a second connecting part 121 corresponding to the first connecting part 111. The first connecting part 111 is, for example, a sliding rail extending along a first axis A1, and is disposed on a side close to the second body 120, for example, at an upper right corner of the first body 110. The second connecting part 121 includes, for example, a sliding block slidably disposed on the sliding rail.

The second connecting part 121 is movably disposed on the first connecting part 111, so that the second body 120 is movably arranged on the first body 110 between a first position P1 (FIG. 2A) and a second position P2 (FIG. 3A) along the first axis A1. In the embodiment, when the second body 120 is located at the first position P1, the second connecting part 121 is located at an upper end of the first connecting part 111 (sliding rail). When the second body 120 is located at the second position P2, the second connecting part 121 is located at a lower end of the first connecting part 111 (sliding rail).

By comparing FIG. 2A and FIG. 3A, it is learned that when the second body 120 is located at the second position P2 relative to the first body 110, the second body 120 may be closer to the user, so as to present another use mode, which is relatively suitable for the user to type, and may reduce probability of wrist pain caused by using the keyboard to type for a long time.

In addition, as shown in FIG. 2A and FIG. 2B, when the second body 120 is located at the first position P1 relative to the first body 110, the keyboard module 100 may be rotated along a second axis A2 (indicated in FIG. 1) by an angle to reach a first rotation position P1′ (FIG. 2B) while taking the second connecting part 121 as a rotation center, so as to present another use mode to provide the user with another choice, which may be more suitable for a posture of playing a video game.

Similarly, as shown in FIG. 3A and FIG. 3B, when the second body 120 is located at the second position P2 relative to the first body 110, the keyboard module 100 may be rotated along the second axis A2 by an angle to reach a second rotation position P2′ (FIG. 3B) while taking the second connecting part 121 as a rotation center, so as to present still another use mode. Therefore, the user may adjust the keyboard module 100 to a suitable use mode to meet the needs of different operations.

Moreover, the keyboard module 100 may also allow the second body 120 to move down directly along the first axis A1 from the first rotation position P1′ in FIG. 2B to the second rotation position P2′ in FIG. 3B. Similarly, the keyboard module 100 may also allow the second body 120 to move up directly along the first axis A1 from the second rotation position P2′ in FIG. 3B to the first rotation position P1′ in FIG. 2B.

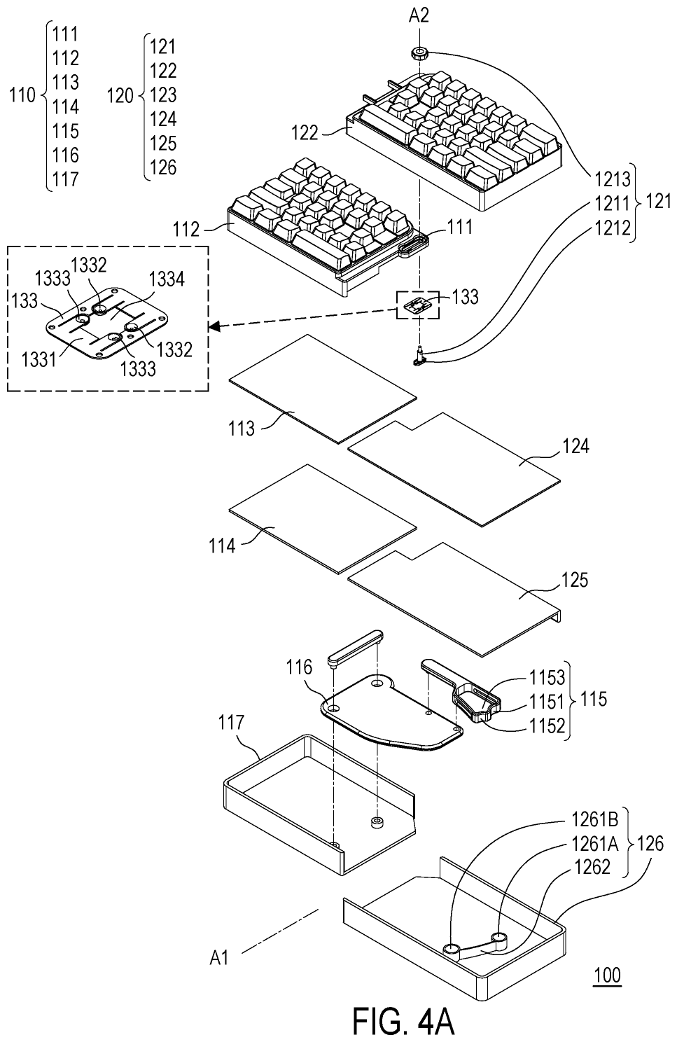

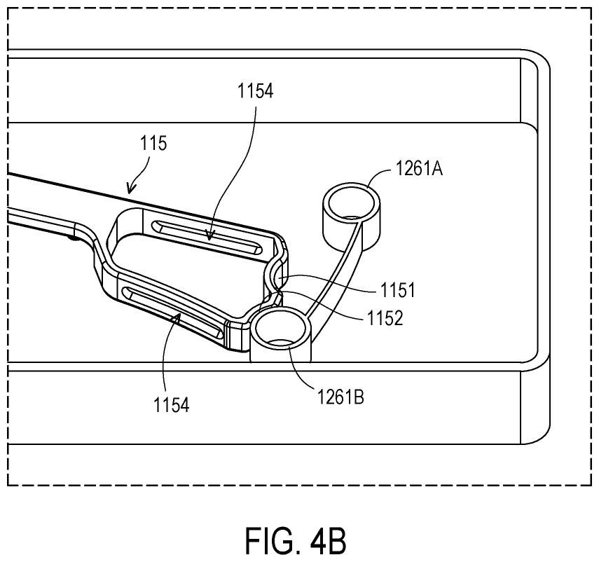

FIG. 4A is an exploded view of a keyboard module of FIG. 1. Referring to FIG. 4A, the first body 110 further sequentially includes a first keyboard member 112, a first circuit member 113, a first support member 114, a first positioning member 115, an extension member 116 and a first bottom case 117 along the second axis A2. The second body 120 further sequentially includes a second keyboard member 122, a second circuit member 124, a second support member 125 and a second bottom case 126 along the second axis A2.

In the embodiment, the second connecting part 121 and the second keyboard member 122 (marked in FIG. 4A) are two separate parts, and the second connecting part 121 is disposed through the second keyboard member 122. In other embodiments, the second connecting part 121 and the second keyboard member 122 may also be integrated.

The first support member 114 and the second support member 125 are respectively disposed on the first bottom case 117 and the second bottom case 126 to serve as a carrier platform for the first circuit member 113 and the second circuit member 124 to provide a good support effect to the first circuit member 113 and the second circuit member 124.

In the embodiment, the first circuit member 113 and the second circuit member 124 are hard circuit boards, and the first circuit member 113 and the second circuit member 124 are electrically connected through a flexible flat cable, but the invention is not limited thereto. In other embodiments, the first circuit member 113 and the second circuit member 124 may also be two flexible circuit boards, or a combination of a rigid circuit board and a flexible circuit board.

Moreover, in the embodiment, the extension member 116 is fixed to the first bottom case 117, and the extension member 116 extends from the first bottom case 117 toward the second bottom case 126 to a position between the second support member 125 and the second bottom case 126.

The first positioning member 115 is fixed to the extension member 116, and a part of the first positioning member 115 is located above the second bottom case 126. In the embodiment, the first positioning member 115 includes a first sub-section 1151, a second sub-section 1152 and a hollow region 1153. The hollow region 1153 may provide space for deformation of the first sub-section 1151 and the second sub-section 1152, so that the first sub-section 1151 and the second sub-section 1152 may be easily deformed.

The second bottom case 126 includes a second positioning member 1261A, a second positioning member 1261B and a reinforcing wall 1262. In the embodiment, the second positioning member 1261A and the second positioning member 1261B are arranged along an arc, and the arc corresponds to a rotation trajectory of the second body 120 relative to the first body 110. Therefore, when the second body 120 is rotated relative to the first body 110 from the first position P1 to the first rotation position P1′, the first sub-section 1151 may be moved from the second positioning member 1261A to the second positioning member 1261B, i.e., the first sub-section 1151 leaves the second positioning member 1261A and is then clipped into the second positioning member 1261B. When the second body 120 is rotated relative to the first body 110 from the second position P2 to the second rotation position P2′, the second sub-section 1152 may be moved from the second positioning member 1261A to the second positioning member 1261B, i.e., the second sub-section 1152 leaves the second positioning member 1261A and is then clipped into the second positioning member 1261B.

In addition, the reinforcing wall 1262 is connected between the two second positioning members 1261A, 1261B, which may be used to increase a structural strength of the two second positioning members 1261A, 1261B.

FIG. 4B is a schematic diagram of the first positioning member and the second positioning member of FIG. 4A. Referring to FIG. 4B, in the embodiment, the first positioning member 115 further includes a hole 1154 formed on a side wall, such a design avails deformation of the first sub-section 1151 and the second sub-section 1152 to improve a feel of use.

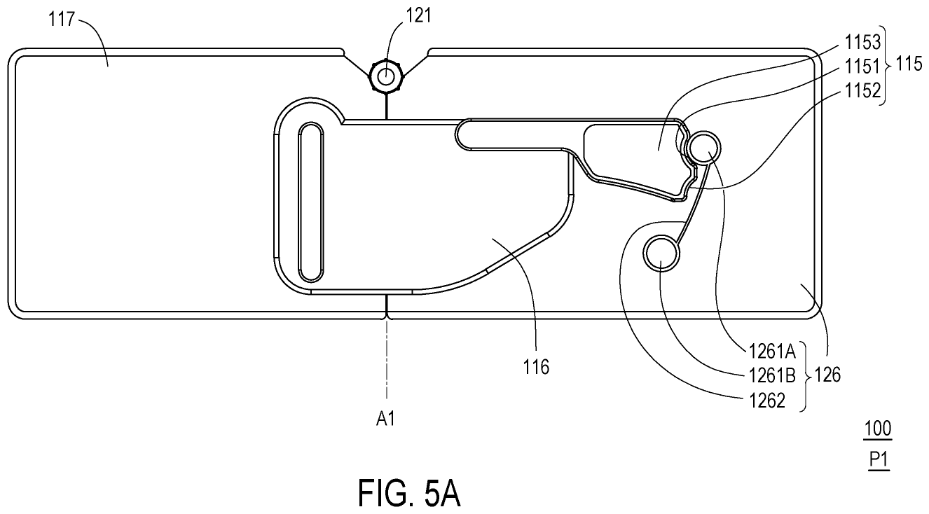

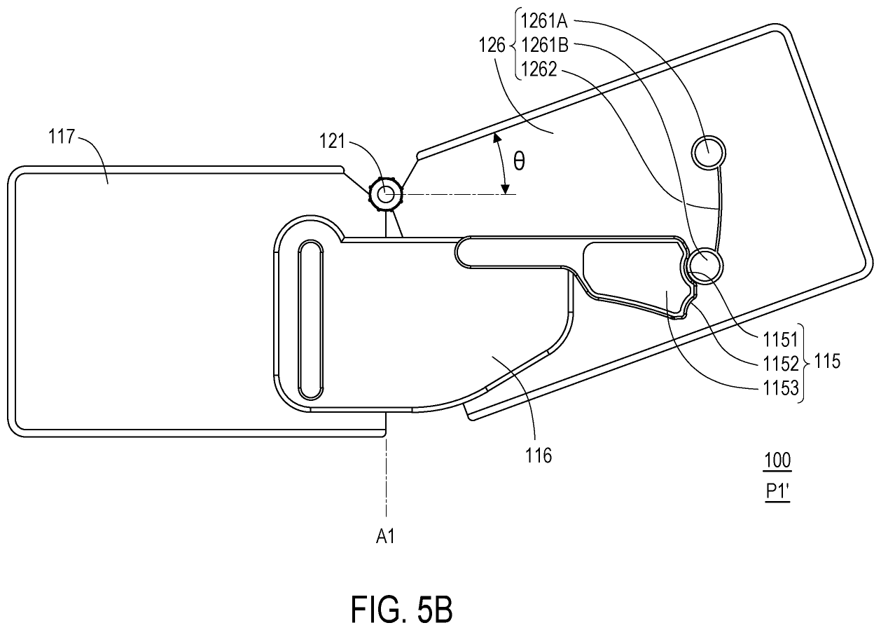

FIG. 5A and FIG. 5B are respectively schematic top views of internal positioning members of the keyboard module of FIG. 2A and FIG. 2B. Referring to FIG. 5A and FIG. 5B, in the embodiment, an outer contour of the first sub-section 1151 of the first positioning member 115 corresponds to an outer contour of the second positioning members 1261A and 1261B in a male-female fitting manner. Therefore, the first sub-section 1151 of the first positioning member 115 may be selectively engaged with the second positioning member 1261A or the second positioning member 1261B, so as to position the second body 120 at the first position P1 or the first rotation position P1′.

To be specific, as shown in FIG. 5A, the second body 120 and the first body 110 may be fixed at the first position P1 through engaging of the first sub-section 1151 of the first positioning member 115 with the second positioning member 1261A. As shown in FIG. 5B, if the user rotates the second body 120 relative to the first body 110 counterclockwise around the second axis A2 while taking the second connecting part 121 as a center, the first sub-section 1151 may be moved toward the hollow region 1153 and slightly deformed, and leave the second positioning member 1261A to be positioned at the second positioning member 1261B, and the second body 120 is fixed to the first rotation position P1′. In the embodiment, an angle θ of the second body 120 rotated relative to the first body 110 is, for example, 20 degrees, but the invention is not limited thereto.

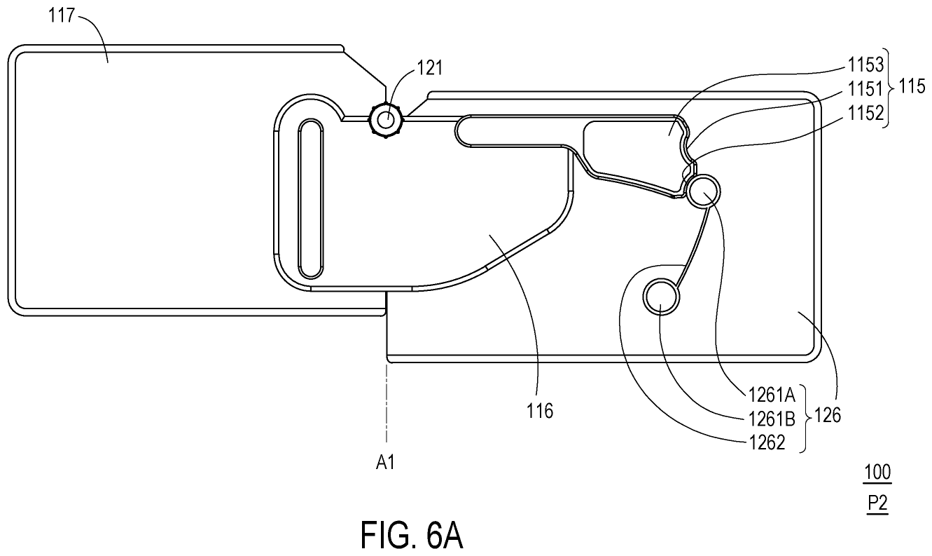

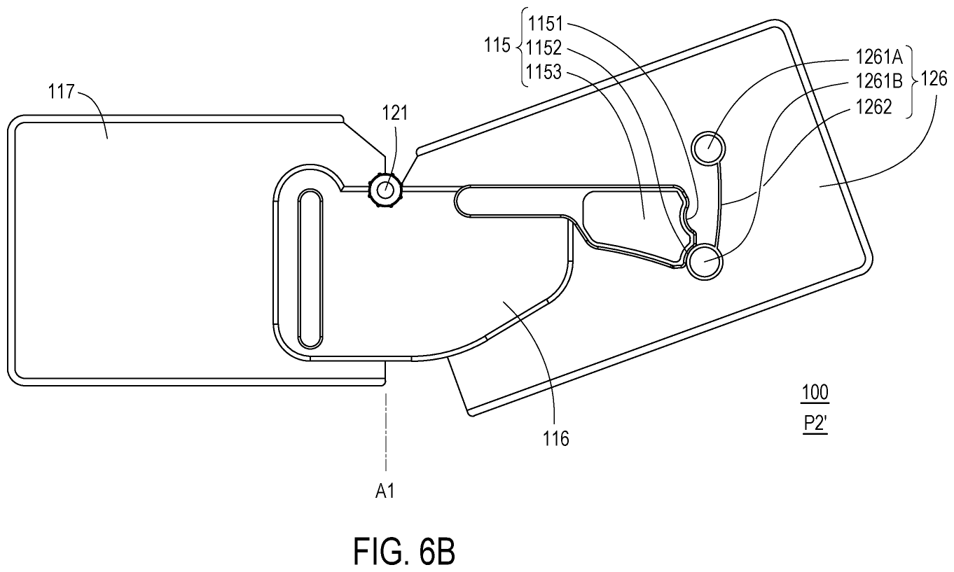

FIG. 6A and FIG. 6B are respectively schematic top views of the internal positioning members of the keyboard module of FIG. 3A and FIG. 3B. Referring to FIG. 6A and FIG. 6B, similarly, in the embodiment, an outer contour of the second sub-section 1152 of the first positioning member 115 corresponds to an outer contour of the second positioning members 1261A and 1261B in a male-female fitting manner. Therefore, the second sub-section 1152 of the first positioning member 115 may be selectively engaged with the second positioning member 1261A or the second positioning member 1261B, so as to position the second body 120 at the second position P2 or the second rotation position P2′.

From FIG. 6A, it is learned that the second body 120 and the first body 110 may be fixed at the second position P2 through engaging of the second sub-section 1152 of the first positioning member 115 with the second positioning member 1261A. Moreover, as shown in FIG. 6B, if the user rotates the second body 120 relative to the first body 110 counterclockwise around the second axis A2 while taking the second connecting part 121 as a center, the second sub-section 1152 may be moved toward the hollow region 1153 and slightly deformed, and leave the second positioning member 1261A to be positioned at the second positioning member 1261B, and the second body 120 is fixed to the second rotation position P2′. In other embodiment, the number and position of the second positioning member are not limited by the drawings, and more fixed positions of the second body 120 after rotation may be provided.

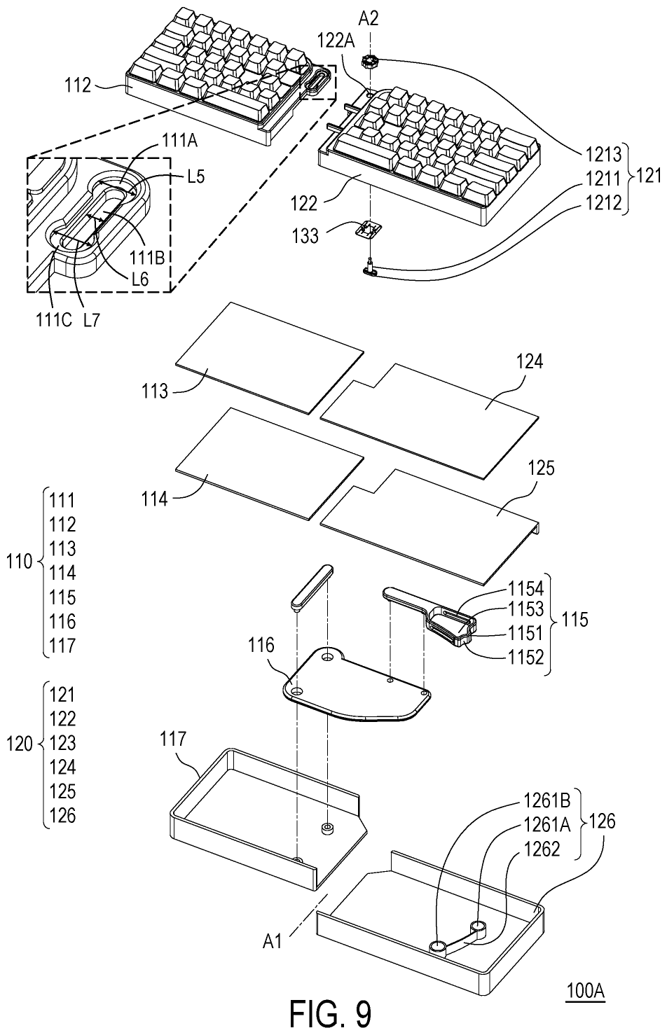

In addition, referring back to FIG. 4A, in the embodiment, the second connecting part 121 includes a sliding block 1211, a position-limiting portion 1212 and a fixing member 1213. The sliding block 1211 is a cylinder, so that the sliding block 1211 is easily rotated along the second axis A2. The sliding block 1211 and the position-limiting portion 1212 may be an integral structure, and the sliding block 1211 may be fixed to the fixing member 1213 by gluing or screwing, which is not limited in the invention. In other embodiments, the shape of the sliding block 1211 may also be polygonal, such as rectangular, as long as the sliding block 1211 may be rotated at a first end 111A (marked in FIG. 9) and a second end 111C (marked in FIG. 9) of the first connecting part 111.

In the embodiment, in order to prevent the second body 120 from easily moving relative to the first body 110 along the first axis A1 due to the user's accidental touch, an interference member 133 is fixed to a non-keyed surface of the first keyboard member 112 along the second axis A2, and is disposed corresponding to the first connecting part 111. The sliding block 1211 sequentially penetrates through a through slot 1334 of the interference member 133, the first connecting part 111 (FIG. 4A) of the first keyboard member 112 and a hole of the second keyboard member 122 (such as a hole 122A marked in FIG. 9), and is combined with the fixing member 1213. The assembled sliding block 1211 of the second connecting part 121 may slide along the sliding rail of the first connecting part 111.

In the embodiment, the interference member 133 includes a plate body 1331, two first positioning portions 1332 and two second positioning portions 1333. The through slot 1334 is formed on the plate body 1331, the two first positioning portions 1332 are located on two sides of the through slot 1334, and the two second positioning portions 1333 are located on the two sides of the through slot 1334. In the embodiment, the two first positioning portions 1332 and the two second positioning portions 1333 are four protrusions protruding from the plate body 1331. In other embodiments, the number of the first positioning portion 1332 and the number of the second positioning portion 1333 may also be only one.

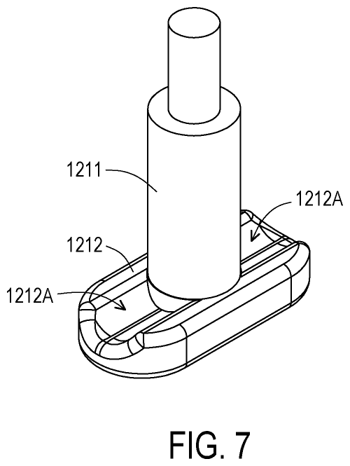

FIG. 7 is a schematic enlarged view of a sliding block and a position-limiting portion of the second connecting part of FIG. 1. Referring to FIG. 7, in the embodiment, the position-limiting portion 1212 is rod-like, and the position-limiting portion 1212 has two arc-shaped grooves 1212A on the side facing the sliding block 1211. The two arc-shaped grooves 1212A are used for collaborating with the first the positioning portions 1332 or the second positioning portions 1333 to fix the relative position.

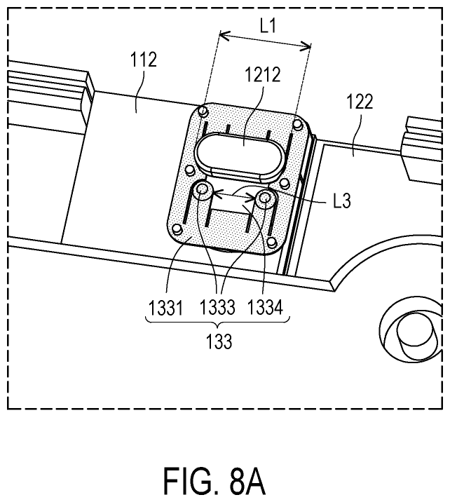

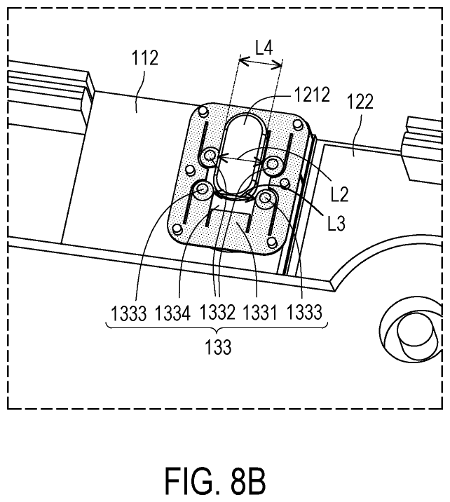

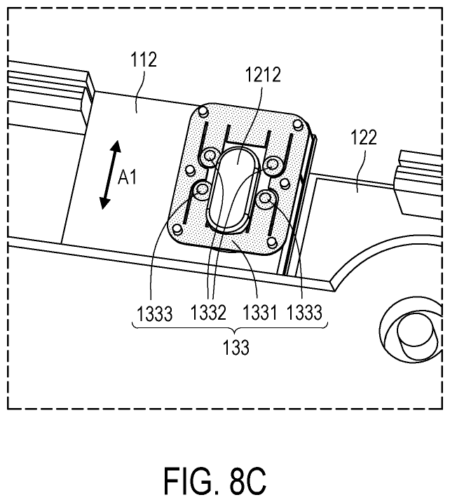

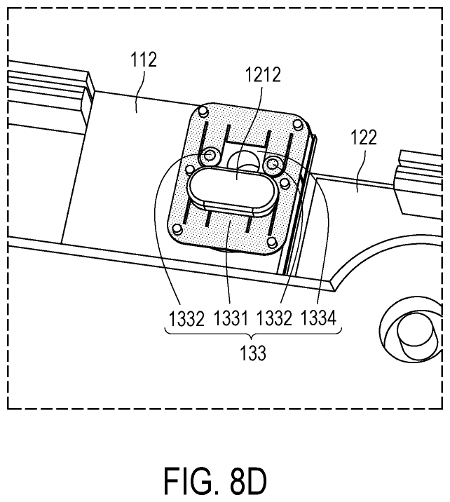

To be specific, FIG. 8A to FIG. 8D are schematic diagrams illustrating movement of the position-limiting portion of the keyboard module of FIG. 1 relative to the interference member. Referring to FIG. 4A, FIG. 7 and FIG. 8A, in the embodiment, a length L1 (FIG. 8A) of the position-limiting portion 1212 is greater than a distance L2 (FIG. 8B) between the two first positioning portions 1332, and is also greater than a length L3 (FIG. 8B) between the two second positioning portions 1333. Therefore, when the position-limiting portion 1212 is located at the position shown in FIG. 8A, the position-limiting portion 1212 may cover the two first positioning portions 1332, so that the two first positioning portions 1332 are located in the two arc-shaped grooves 1212A of the position-limiting portion 1212 and lean against the bottom of the two arc-shaped grooves 1212A. In this way, the relative positions of the second connecting part 121 and the interference member 133 are fixed.

Since the interference member 133 is fixed to the first keyboard member 112, the relative positions of the second connecting part 121 and the first keyboard member 112 are also fixed. In addition, since the second connecting part 121 passes through the hole of the second keyboard member 122, the second keyboard member 122 may be rotated relative to the second connecting part 121, but the second keyboard member 122 will be restricted by the arc groove 1212A of the second connecting part 121 positioned to the first positioning portions 1332 of the interference member 133, and cannot move relative to the first keyboard member 112 along the first axis A1.

Therefore, when the position-limiting portion 1212 is located at the position shown in FIG. 8A, the second body 120 may not be moved relative to the first body 110, and the second body 120 may only be rotated relative to the first body 110, and is located at the first position P1 or the first rotation position P1′. In this way, the second body 120 will not be moved to the second position P2 or the second rotation position P2′ relative to the first body 110 along the first axis A1 due to the user's accidental touch or incorrect operation.

When the user wants to move the second body 120 downward relative to the first body 110 along the first axis A1, the user may rotate the fixing member 1213 (shown in FIG. 4A) of the second connecting part 121 to make the position-limiting portion 1212 to rotate to the position shown in FIG. 8B.

As shown in FIG. 8B, in the embodiment, a width L4 of the position-limiting portion 1212 is less than the distance L2 between the two first positioning portions 1332, and is less than the distance L3 between the two second positioning portions 1333. In some embodiments, the width L4 of the limiting portion 1212 may be wider than a width of the through slot 1334 of the interference member 133 to prevent the two parts from being separated.

After the position-limiting portion 1212 is rotated by 90 degrees and extends in an up-down direction as shown in FIG. 8B, the position-limiting portion 1212 is staggered from the first positioning portions 1332, and the position-limiting portion 1212 may be moved to a position shown in FIG. 8C relative to the interference member 133 along the first axis A1. In the process of FIG. 8B to 8C, the second connecting part 121 penetrating through the hole of the second body 120 may also drive the second body 120 to move to the second position P2 (FIG. 3A) along the first axis A1 relative to the first body 110.

In order to prevent the second body 120 from leaving the second position P2 or the second rotation position P2′ due to the user's accidental touch, the user may again turn the fixing member 1213 (FIG. 4A) of the second connecting part 121 to rotate the position-limiting portion 1212 to a position shown in FIG. 8D. At this time, the position-limiting portion 1212 may cover the two second positioning portions 1333, so that the two second positioning portions 1333 are located in the two arc-shaped grooves 1212A (FIG. 7) of the limiting portion 1212 to lean against the bottom of the two arc-shaped grooves 1212A (FIG. 7). Therefore, the relative positions of the position-limiting portion 1212 and the interference member 133 are fixed again.

In this way, when the position-limiting portion 1212 is located at the position shown in FIG. 8D, the second body 120 may not be moved relative to the first body 110, the second body 120 may only be rotated relative to the first body 110, and is located at the second position P2 or the second rotation position P2′. It will not affect the user's use experience as the user mistakenly moves the second body 120 relative to the first body 110 along the first axis A1 when typing or playing games.

It should be noted that the arrangement position of the interference member 133 is not limited to that described above. Another embodiment is introduced below, it should be noted that, in the following embodiment, the same or similar elements as those of the previous embodiment are represented by the same or similar symbols, details thereof are not repeated, and only differences there between are described.

FIG. 9 is a schematic exploded view of a keyboard module according to another embodiment of the invention. Referring to FIG. 9, main differences between a keyboard module 100A of FIG. 9 and the keyboard module 100 of FIG. 4A lie in a configuration position of the interference member 133, an assembling sequence of the sliding block 1211 and a form of the fixing member 1213.

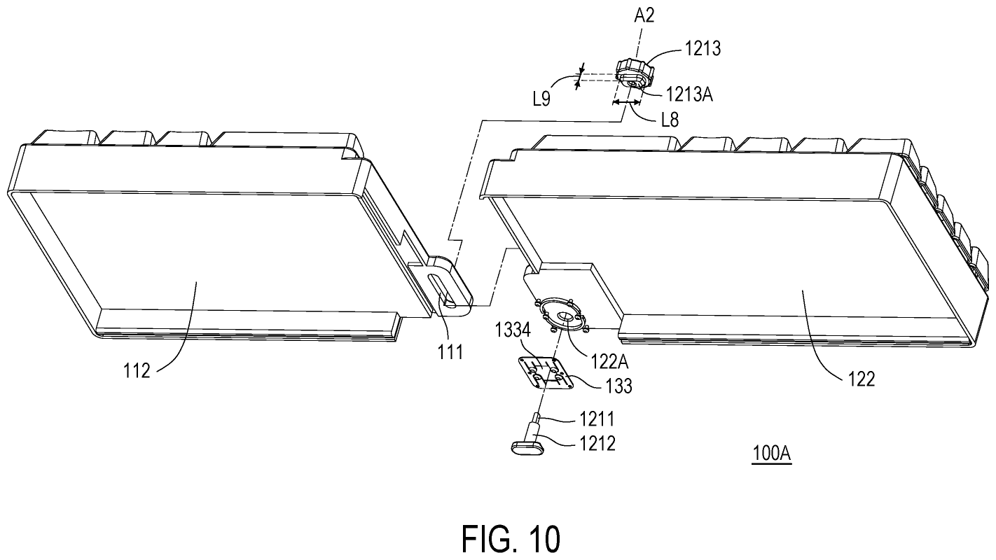

FIG. 10 is a partial schematic view of FIG. 9 from another viewing angle. Referring to FIG. 10, in the embodiment, the interference member 133 is disposed on a bottom surface of the second keyboard member 122 by, for example, thermal fusion, and the through slot 1334 of the interference member 133 corresponds to a hole 122A of the second keyboard member 122. One end (an upper end in FIG. 10) of the sliding block 1211 sequentially passes through the through slot 1334 of the interference member 133, the hole 122A of the second keyboard member 122, and the first connecting part 111 (sliding rail) from bottom to top, and is then connected to the fixing member 1213, and the other end (a lower end in FIG. 10) of the sliding block 1211 is connected to the position-limiting portion 1212. Therefore, after assembly, the second keyboard member 122 is located between the position-limiting portion 1212 and the fixing member 1213.

In the embodiment, the fixing member 1213 includes a stopper portion 1213A facing the first connecting part 111 (sliding rail). The stopper portion 1213A is has a strip shape. Referring back to FIG. 9, the first connecting part 111 (sliding rail) includes a first end 111A, a second end 111C, and a middle section 111B connected to the first end 111A and the second end 111C. A width L5 of the first end 111A and a width L7 of the second end 111C are larger than a width L6 of the middle section 111B. A length L8 of the stopper portion 1213A (FIG. 10) is less than the width L5 of the first end 111A and the width L7 of the second end 111C, and is greater than the width L6 of the middle section 111B, and a width L9 of the stopper portion 1213A is less than the width L7 of the middle section 111B.

Therefore, when an extending direction of the stopper portion 1213A is parallel to an extending direction of the first connecting part 111 (sliding rail), the stopper portion 1213A may be moved from the first end 111A to the second end 111C through the middle section 111B, or vice versa. When the extending direction of the stopper portion 1213A is perpendicular to the extending direction of the first connecting part 111 (sliding rail), if the stopper portion 1213A is located at the first end 111A, the stopper portion 1213A will be blocked by an edge of the first end 111A, and cannot be moved to the middle section 111B. When the extending direction of the stopper portion 1213A is perpendicular to the extending direction of the first connecting part 111 (sliding rail), if the stopper portion 1213A is located at the second end 111C, the stopper portion 1213A will be blocked by an edge of the second end 111C, and cannot be moved to the middle section 111B.

In other words, the user may control whether the second body 120 may move relative to the first body 110 along the first axis A1 by rotating the fixing member 1213.

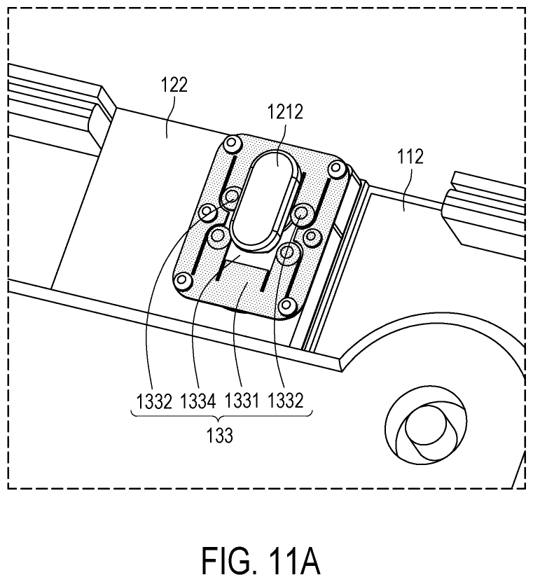

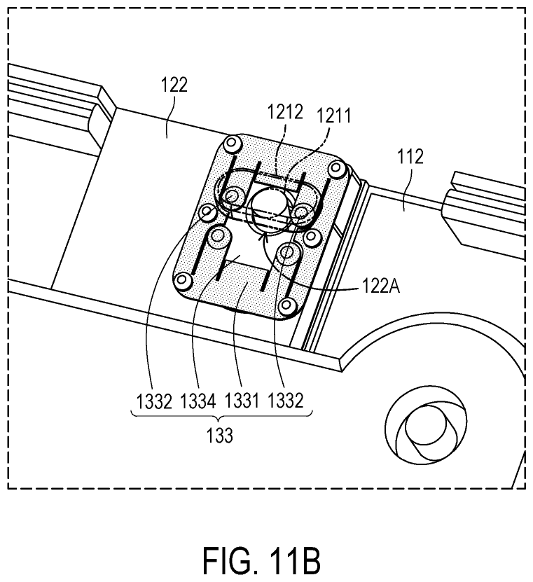

FIG. 11A and FIG. 11B are schematic diagrams of movement of the position-limiting portion of FIG. 9 relative to the interference member. Referring to FIG. 11A and FIG. 11B, in the embodiment, the interference member 133 is fixed on the second keyboard member 122, and the sliding block 1211 passes through the hole 122A (FIG. 11B) of the second keyboard member 122, and the second connecting part 121 may only be rotated relative to the second keyboard member 122, but may not be moved relative to the second keyboard member 122. Therefore, in the embodiment, the position-limiting portion 1212 may only be engaged with the first positioning portions 1332. The engaging relationship between the position-limiting portion 1212 and the first positioning portions 1332 may be used to fix the relative positions between the second connecting part 121 and the second keyboard member 122.

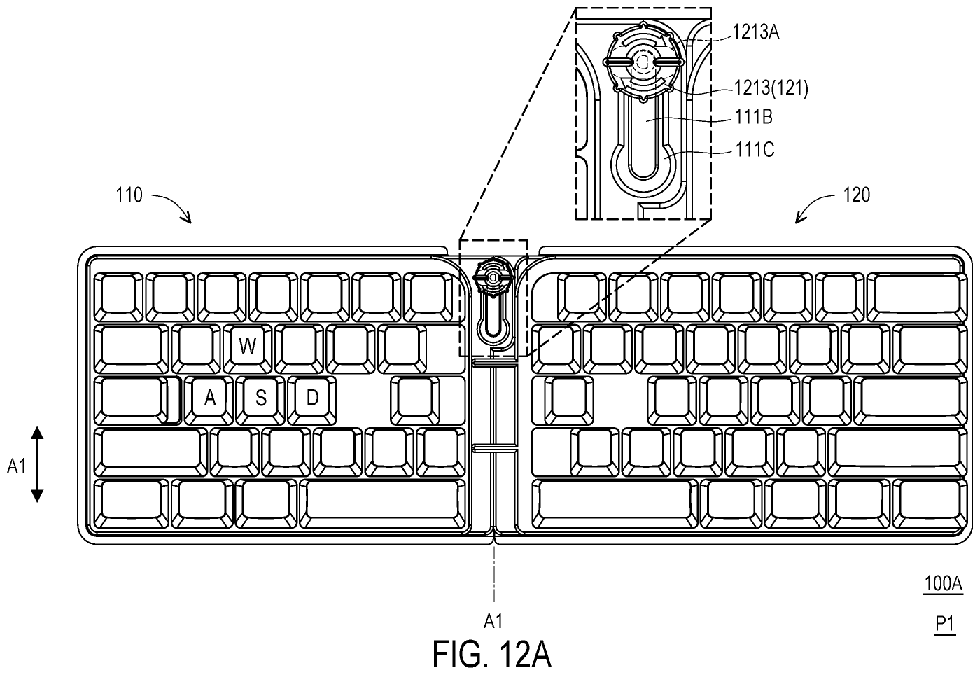

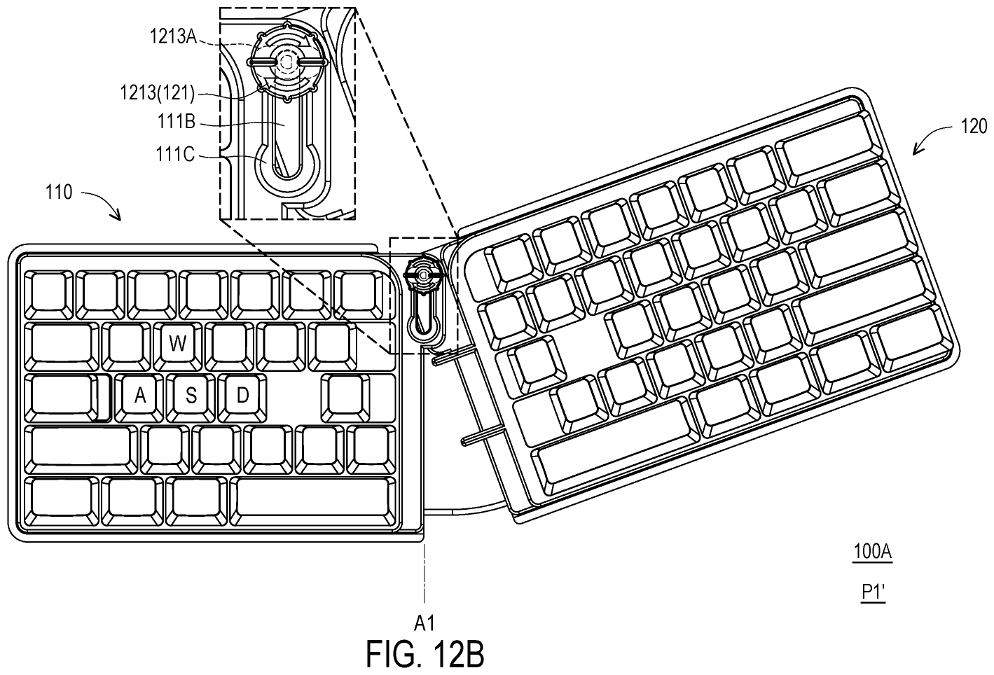

FIG. 12A and FIG. 12B are schematic top views of the second body of the keyboard module of FIG. 9 that is rotatably disposed on the first body 110 at the first position. Referring to FIG. 12A and FIG. 12B, when the second body 120 is located at the first position P1 and the first rotation position P1′ relative to the first body 110, the extending direction of the stopper portion 1213A is perpendicular to the first axis A1, which may prevent the second body 120 from moving relative to the first body 110 along the first axis A1. At the same time, the arc-shaped groove 1212A of the second connecting part 121 is positioned at the first positioning portions 1332 of the interference member 133.

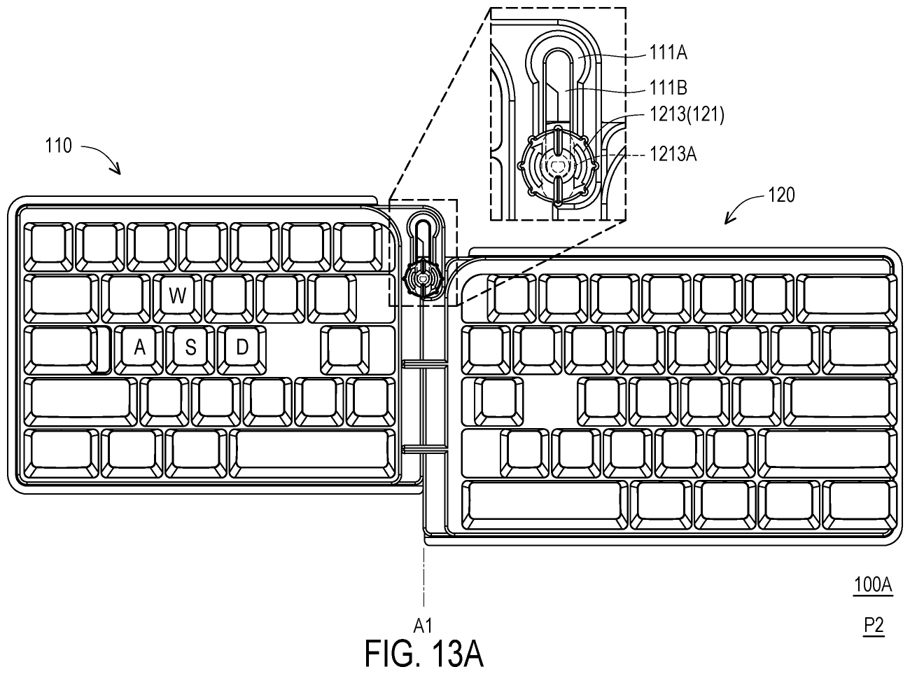

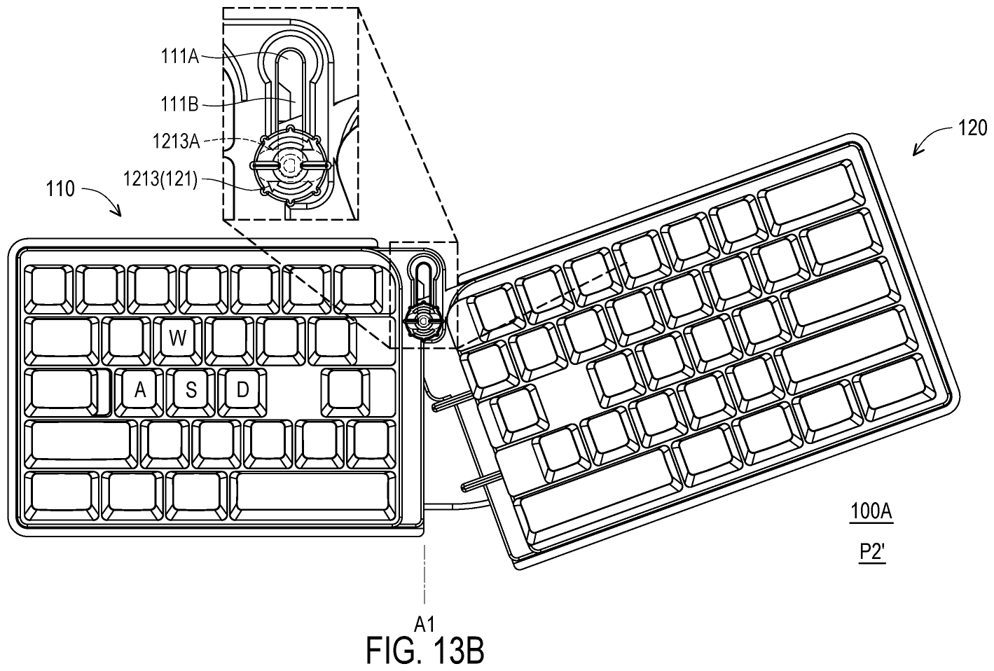

FIG. 13A and FIG. 13B are schematic top views of the second body of the keyboard module of FIG. 9 that is rotatably disposed on the first body 110 at the second position. Referring to FIG. 13A and FIG. 13B, when the second body 120 is to be moved relative to the first body 110 along the first axis A1, the connecting member 1213 needs to be rotated first so that the extending direction of the stopper portion 1213A is parallel to the first axis A1, and the stopper portion 1213A may enter the second end 111C through the middle section 111B, and move to the second position P2 of FIG. 13A. Then, as long as the connecting member 1213 is rotated again so that the extending direction of the stopper portion 1213A is perpendicular to the first axis A1 (FIG. 13B), the second body 120 may be prevented from moving relative to the first body 110 along the first axis A1. In this way, the second body 120 may be rotated relative to the first body 110 at the second position P2 and the second rotation position P2′ without moving along the first axis A1. At the same time, the arc-shaped groove 1212A of the second connecting part 121 is positioned at the first positioning portions 1332 of the interference member 133.

In summary, in the keyboard module of the invention, as the second body freely switches between the first position and the second position relative to the first body, when typing and operating direction keys, a user may adjust the keyboard module along the first axis to a position where the wrist stays comfortable. In addition, in the keyboard module of the invention, the second body is rotatably disposed on the first body, so that the user may not only adjust a wrist position along the first axis but also rotate the second body along the second axis to improve the comfort of the wrist during use. In this way, when typing or playing games with the keyboard module of the invention, the user may keep the wrist in a comfortable operating posture, so as to reduce the probability of wrist pain caused by typing or playing games with a keyboard for a long time.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A keyboard module, comprising:
a first body, comprising a first connecting part; and
a second body, electrically connected to the first body and comprising a second connecting part, wherein the second connecting part is movably disposed at the first connecting part, so that the second body is movably disposed at a first position and a second position related to the first body along a first axis, and the second body is rotatably disposed at at least one of the first position and the second position related to the first body along a second axis.

2. The keyboard module as claimed in claim 1, wherein the first body comprises a first bottom case and a first positioning member fixed to the first bottom case, the second body comprises a second bottom case, the first positioning member extends to the second bottom case, the second bottom case comprises a plurality of second positioning members, and the first positioning member is movably positioned to one of the second positioning members.

3. The keyboard module as claimed in claim 2, wherein the first positioning member comprises a first sub-section and a second sub-section, the first sub-section is positioned to one of the second positioning members when the second body is located at the first position relative to the first body, and
the second sub-section is positioned to one of the second positioning members when the second body is located at the second position relative to the first body.

4. The keyboard module as claimed in claim 3, wherein an outer contour of any one of the first sub-section and the second sub-section corresponds to an outer contour of the second positioning member in a male-female fitting manner.

5. The keyboard module as claimed in claim 2, wherein the second positioning members are arranged along an arc, the second bottom case comprises a reinforcing wall connected between the second positioning members.

6. The keyboard module as claimed in claim 2, wherein the first positioning member comprises a hollow region adapted to provide a space for deformation of the first positioning member, so that the first positioning member is clipped into or separated from one of the second positioning members.

7. The keyboard module as claimed in claim 2, wherein the first body comprises a first keyboard member, a first circuit member, a first support member and the first bottom case arranged in sequence along the second axis, the second body comprises a second keyboard member, a second circuit member, a second support member and the second bottom case arranged in sequence along the second axis, and the first positioning member and the second positioning member are located between the second support member and the second bottom case.

8. The keyboard module as claimed in claim 7, wherein the first body comprises an extension member fixed to the first bottom case and extending from a position between the first support member and the first bottom case to a position between the second support member and the second bottom case, and the first positioning member is fixed to the extension member.

9. The keyboard module as claimed in claim 7, further comprising a flexible flat cable connected to the first circuit member and the second circuit member.

10. The keyboard module as claimed in claim 1, wherein the first connecting part comprises a sliding rail, the second body comprises a second keyboard member, an interference member is disposed on the sliding rail or the second keyboard member, and the second connecting part is disposed through the interference member, the sliding rail and the second keyboard member.

11. The keyboard module as claimed in claim 10, wherein the interference member comprises a through slot, the second connecting part comprises a sliding block and a position-limiting portion, the sliding block is disposed through the through slot, the sliding rail and the second keyboard member, and the position-limiting portion is connected to the sliding block and located beside the interference member.

12. The keyboard module as claimed in claim 11, wherein the interference member comprises a plate body and at least one first positioning portion, the through slot is formed in the plate body, the second body is adapted to move along the first axis when the position-limiting portion is staggered from the at least one first positioning portion, and movement of the second body on the first axis is limited when the position-limiting portion is rotated to be engaged with the at least one first positioning portion.

13. The keyboard module as claimed in claim 12, wherein the position-limiting portion has at least one arc-shaped groove on a side facing the sliding block, and the at least one first positioning portion is convex.

14. The keyboard module as claimed in claim 12, wherein the interference member is disposed on a bottom surface of the first connecting part, the through slot corresponds to the sliding rail, and the sliding block is sequentially disposed through the through slot, the sliding rail and the second keyboard member.

15. The keyboard module as claimed in claim 14, wherein the interference member further comprises at least one second positioning portion, the second body is adapted to move along the first axis when the position-limiting portion is staggered from the at least one second positioning portion, and movement of the second body on the first axis is limited when the position-limiting portion is rotated to be engaged with the at least one second positioning portion.

16. The keyboard module as claimed in claim 15, wherein the at least one first positioning portion comprises two first positioning portions, the at least one second positioning portion comprises two second positioning portions, the two first positioning portions are located on two sides of the through slot, the two second positioning portions are located on the two sides of the through slot, the position-limiting portion is long stripe-shaped, a width of the position-limiting portion is less than a distance between the two first positioning portions and less than a distance between the two second positioning portions, and a length of the position-limiting portion is greater than the distance between the two first positioning portions and greater than the distance between the two second positioning portions.

17. The keyboard module as claimed in claim 11, wherein the second keyboard member comprises a hole, the interference member is disposed on a bottom surface of the second keyboard member, the through slot corresponds to the hole, the second connecting part comprises a fixing member, and the sliding block sequentially passes through the through slot, the hole and the sliding rail to be connected to the fixing member, so that the second keyboard member is located between the position-limiting portion and the fixing member.

18. The keyboard module as claimed in claim 17, wherein the fixing member comprises a stopper portion facing the sliding rail, the sliding rail comprises a first end, a second end and a middle section connected to the first end and the second end, a width of the first end and a width of the second end are greater than a width of the middle section, a length of the stopper portion is less than the width of the first end and the width of the second end and greater than the width of the middle section, and a width of the stopper portion is less than the width of the middle section.
